(19) United States
(12) Patent Application Publication
(10) Pub. No.: US 2010/0013820 A1
(43) Pub. Date: Jan. 21, 2010

(54) METHOD OF DRIVING PLASMA DISPLAY PANEL AND PLASMA DISPLAY APPARATUS USING THE METHOD

(76) Inventors: Suk-Jae Park, Suwon-si (KR); Yeon-Sung Jung, Suwon-si (KR)

Correspondence Address: CHRISTIE, PARKER & HALE, LLP, PO BOX 7068, PASADENA, CA, 91109-7068, US

(21) Appl. No.: 12/411,117

(22) Filed: Mar. 25, 2009

(30) Foreign Application Priority Data
Jul. 21, 2008 (KR) 10-2008-0070796

(51) Int. Cl. G06F 3/038; G09G 3/28

(52) U.S. Cl. 345/213; 345/60

(57) ABSTRACT

A method of driving a plasma display device, having a time-divisionally driven gray scale utilizing a reset period in which wall charges of all cells of a plasma display panel (PDP) are initialized, an address period for enabling a sustain discharge by generating a weak discharge in selected cells, and a sustain period in which the sustain discharge is generated in the selected cells. Further, an erase discharge is generated in all the cells of the PDP early in the sustain period.

### CROSS-REFERENCE TO RELATED PATENT APPLICATIONS

This application claims the priority to and the benefit of Korean Patent Application No. 10-2008-0070796, filed on Jul. 21, 2008, in the Korean Intellectual Property Office, the disclosure of which is incorporated herein in its entirety by reference.

### BACKGROUND

1. Field of the Invention

The present invention relates to a method of driving a plasma display panel (PDP), and more particularly, to a method of driving a PDP which includes a reset period in which wall charges of all cells of the PDP are initialized, an address period in which an address discharge is generated in selected cells for a sustain discharge, and a sustain period in which a sustain discharge is generated in the selected cells.

2. Description of the Related Art

In a conventional plasma display apparatus, an image frame is divided into a plurality of subfields utilizing time division to display a spectrum of gray levels, and each of the subfields includes a reset period, an address period, and a sustain period. Each of the subfields has its own gray level weight, and a sustain discharge occurs during a time proportional to the gray level weight of each of the subfields.

A drawback of conventional methods of driving a plasma display panel (PDP) is that a reset or address operation may be nonuniform in all cells due to properties of phosphor materials, coating thickness, barrier rib height, and so on.

For example, in a non-selected cell in which a discharge is not intended, if an abnormal operation occurs during a reset period, although an address discharge is not generated during an address period, a sustain discharge may still be generated in the cell during a sustain period.

Also, when a discharge is intended only to occur in a selected cell during an address period, a discharge may occur in a non-selected cell adjacent to the selected cell, thereby generating a sustain discharge during a sustain period.

When a sustain discharge is initially generated during a sustain period of a subfield, the sustain discharge continuously takes place until the sustain period ends.

Accordingly, image reproducibility may be less than ideal when conventional driving methods are used.

### SUMMARY OF THE INVENTION

Various embodiments of the present invention provide methods of driving a plasma display panel (PDP) and a plasma display apparatus which can improve image reproducibility even though a reset or address operation fails to be uniformly carried out in all cells due to variations in the manufacture of the PDP.

An aspect of the present invention is a method of driving a PDP during a plurality of fields including a plurality of subfields, each subfield comprising a reset period, an address period, and a sustain period, the PDP including scan electrode lines, sustain electrode lines parallel to the scan electrode lines, and address electrode lines crossing the scan electrode lines and the sustain electrode lines at a plurality of cells. The method includes initializing wall charges of all the cells during the reset period; generating a discharge in selected cells of the plurality of cells during the address period to enable a sustain discharge in the selected cells; generating the sustain discharge in the selected cells during the sustain period; and applying an erase pulse to the scan electrode lines early in the sustain period.

During the reset period, wall charges of all the cells of the PDP are initialized. During the address period, a weak discharge is generated in selected cells to enable a subsequent sustain discharge. During the sustain period, the sustain discharge is generated in the selected cells. Early in the sustain period, an erase pulse is applied to the scan electrode lines.

According to another aspect of the present invention, there is provided a plasma display apparatus using the described method.

According to the method and the plasma display apparatus using the method according to various embodiments of the present invention, an erase discharge occurs at the beginning of the sustain period to reduce the wall charges of all the cells of the PDP. Accordingly, even though a reset or address operation may fail to be uniformly carried out in all the cells due to variations in the manufacture of the PDP, image reproducibility is improved for the following reasons.

First, in the selected cells that are properly selected in the address period, sufficient wall charges are formed for a sustain discharge. Accordingly, in these cells, although the wall charges are reduced due to the erase discharge early in the sustain period, a sustain discharge is still normally generated in the selected cells.

Second, the non-selected cells that operate abnormally during the reset period do not have sufficient wall charges for a sustain discharge compared to selected cells that are normally selected during the address period. Accordingly, in these cells, when the wall charges are reduced due to the erase discharge, a sustain discharge is not generated in the non-selected cells during the sustain period.

Third, the cells that are not selected during the addressing period do not have sufficient wall charges for a sustain discharge compared to normally selected cells during the address period. Accordingly, in these cells, when the wall charges are reduced due to the erase discharge, a sustain discharge is not generated in the non-selected cells during the sustain period.

### BRIEF DESCRIPTION OF THE DRAWINGS

The above and other features of the present invention will become more apparent by describing in detail exemplary embodiments thereof with reference to the attached drawings in which:

FIG. 1 is an inner perspective view of a plasma display panel (PDP) according to an embodiment of the present invention;

FIG. 2 is a cross-sectional view illustrating a display cell of the PDP of FIG. 1;

FIG. 3 is a timing diagram illustrating an address-display separation driving method with respect to scan electrode lines of the PDP of FIG. 1;

FIG. 4 is a block diagram of a plasma display apparatus according to an embodiment of the present invention;

FIG. 5 is a timing diagram illustrating driving signals applied to the PDP of FIG. 1 in a subfield, for explaining a method of driving the PDP using the plasma display apparatus of FIG. 4 according to an embodiment of the present invention;

FIG. 6 is an enlarged timing diagram illustrating driving signals during a period from time t57 to time t60 of the subfield of FIG. 5;

FIG. 7A is a cross-sectional view illustrating a wall charge distribution when wall charges are normally accumulated in a cell at time t52 of the subfield of FIG. 5;

FIG. 7B is a cross-sectional view illustrating a wall charge distribution when the cell of FIG. 7A is normally reset at time t54 of the subfield of FIG. 5;

FIG. 7C is a cross-sectional view illustrating a wall charge distribution when the cell of FIG. 7B is normally selected due to an address discharge at time t57 of the subfield of FIG. 5;

FIG. 7D is a cross-sectional view illustrating wall charges left after some wall charges in the normally selected cell of FIG. 7C are erased at time t59 of the subfield of FIGS. 5 and 6;

FIG. 7E is a cross-sectional view illustrating a wall charge distribution after a first sustain discharge occurs in the cell of FIG. 7D at time t60 of the subfield of FIGS. 5 and 6;

FIG. 7F is a cross-sectional view illustrating a wall charge distribution after a second sustain discharge occurs in the cell of FIG. 7E at time t61 of the subfield of FIG. 5;

FIG. 7G is a cross-sectional view illustrating a wall charge distribution after a third sustain discharge occurs in the cell of FIG. 7F at time t62 of the subfield of FIG. 5;

FIG. 8A is a cross-sectional view illustrating a wall charge distribution when wall charges are insufficiently accumulated in a cell at time t52 of the subfield of FIG. 5;

FIG. 8B is a cross-sectional view illustrating that the cell of FIG. 8A is abnormally reset at time t54 of the subfield of FIG. 5;

FIG. 8C is a cross-sectional view illustrating wall charges when the cell of FIG. 8B is not selected at time t57 of the subfield of FIG. 5;

FIG. 8D is a cross-sectional view illustrating wall charges left after some wall charges in the cell of FIG. 8C are erased at time t59 of the subfield of FIGS. 5 and 6;

FIG. 8E is a cross-sectional view illustrating that a sustain discharge does not occur in the cell of FIG. 8D at time t60 of the subfield of FIGS. 5 and 6;

FIG. 9A is a cross-sectional view illustrating a wall charge distribution when wall charges are excessively accumulated in a cell at time t52 of the subfield of FIG. 5;

FIG. 9B is a cross-sectional view illustrating a wall charge distribution when wall charges are excessively accumulated in the cell of FIG. 9A at time t54 of the subfield of FIG. 5;

FIG. 9C is a cross-sectional view illustrating that an address discharge occurs in the cell of FIG. 9B, which is not selected, at time t57 of the subfield of FIG. 5;

FIG. 9D is a cross-sectional view illustrating wall charges left after some wall charges in the cell of FIG. 9C are erased at time t59 of the subfield of FIGS. 5 and 6;

FIG. 9E is a cross-sectional view illustrating that a sustain discharge does not occur in the cell of FIG. 9D at time t60 of the subfield of FIGS. 5 and 6;

FIG. 10 is a timing diagram illustrating driving signals applied to the PDP of FIG. 1 in a subfield, for explaining a method of driving the PDP using the plasma display apparatus of FIG. 4 according to another embodiment of the present invention;

FIG. 11 is an enlarged timing diagram illustrating driving signals during a period from time t57 to time t60 of the subfield of FIG. 10;

FIG. 12 is a cross-sectional view illustrating wall charges left after some wall charges in the cell of FIG. 7C are erased at time t59 of a subfield of FIGS. 10 and 11;

FIG. 13 is a cross-sectional view illustrating wall charges left after some wall charges in the cell of FIG. 8C are erased at time t59 of the subfield of FIGS. 10 and 11;

FIG. 14 is a cross-sectional view illustrating wall charges left after some wall charges in the cell of FIG. 9C are erased at time t59 of the subfield of FIGS. 10 and 11;

FIG. 15 is a timing diagram illustrating driving signals applied to the PDP of FIG. 1 in a subfield, for explaining a method of driving the PDP using the plasma display apparatus of FIG. 4 according to another embodiment of the present invention; and

FIG. 16 is an enlarged timing diagram illustrating driving signals during a period from time t57 to time t60 of the subfield of FIG. 15.

### DETAILED DESCRIPTION OF EXEMPLARY EMBODIMENTS

In the following detailed description, with reference to the accompanying drawings, only certain exemplary embodiments of the present invention are shown and described, by way of illustration. As those skilled in the art would recognize, the invention may be embodied in many different forms and should not be construed as being limited to the embodiments set forth herein.

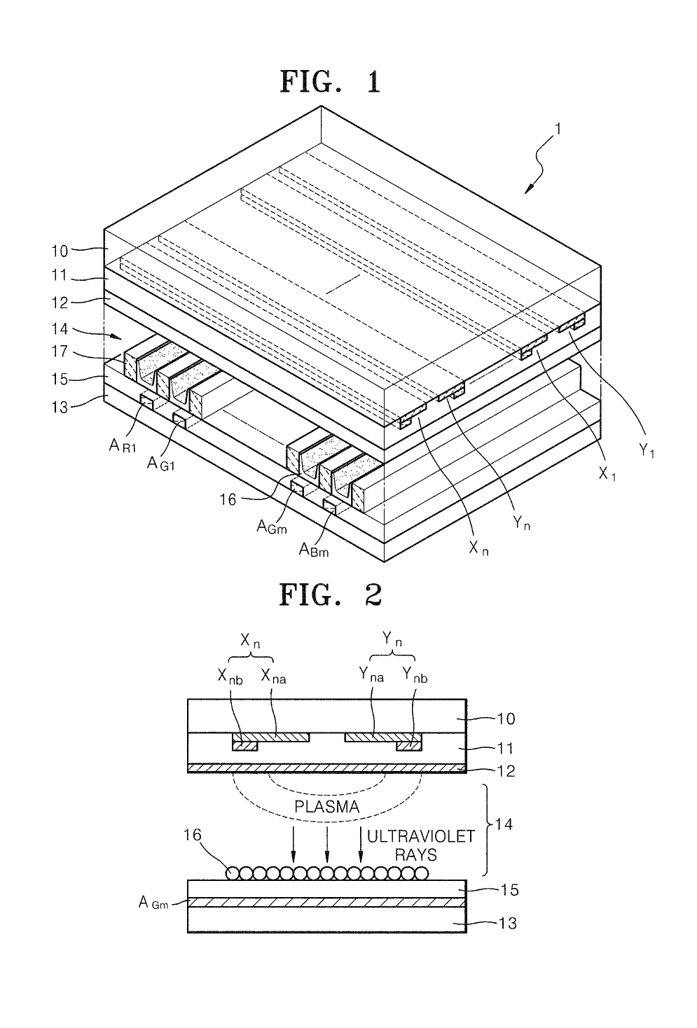

FIG. 1 is a perspective view of a plasma display panel (PDP) 1 according to an exemplary embodiment of the present invention. FIG. 2 is a cross-sectional view illustrating a display cell of the PDP 1 of FIG. 1.

Referring to FIGS. 1 and 2, between a front glass substrate 10 and a rear glass substrate 13 are disposed address electrode line lines A_{R1} through A_{Bm}, front and rear dielectric layers 11 and 15, scan electrode lines Y₁ through Yₙ, sustain electrode lines X₁ through Xₙ, phosphors 16, barrier ribs 17, and a protective layer 12 formed of MgO.

The address electrode lines A_{R1} through A_{Bm} are formed (e.g., in a predetermined pattern) on a front surface of the rear glass substrate 13. The rear dielectric layer 15 is formed on the rear glass substrate 13 to cover the address electrode lines A_{R1} through A_{Bm}. The barrier ribs 17 are formed on the rear dielectric layer 15 parallel to the address electrode lines A_{R1} through A_{Bm}. The barrier ribs 17 define a discharge area of each cell and reduce or prevent optical cross-talk between cells. The phosphors 16 are coated between the barrier ribs 17.

The sustain electrode lines X₁ through Xₙ and the scan electrode lines Y₁ through Yₙ are formed (e.g., in a predetermined pattern) on a rear surface of the front glass substrate 10 to perpendicularly cross the address electrode lines A_{R1} through A_{Bm}. Each crossing region corresponds to one cell. Each pair of the sustain electrode lines X₁ through Xₙ and the scan electrode lines Y₁ through Yₙ is formed by coupling transparent electrodes Xₙₐ and Yₙₐ (see FIG. 2) formed of a transparent conductive material, such as indium tin oxide (ITO), with metal electrodes X_{nb} and Y_{nb} for improving conductivity. The front dielectric layer 11 is formed on the front glass substrate 10 to cover the sustain electrode lines X₁ through Xₙ and the scan electrode lines Y₁ through Yₙ. The protective layer 12 for protecting the PDP 1 from a strong electric field may be formed by entirely coating MgO on the rear surface of the front dielectric layer 11. A plasma forming gas is filled in a discharge space 14.

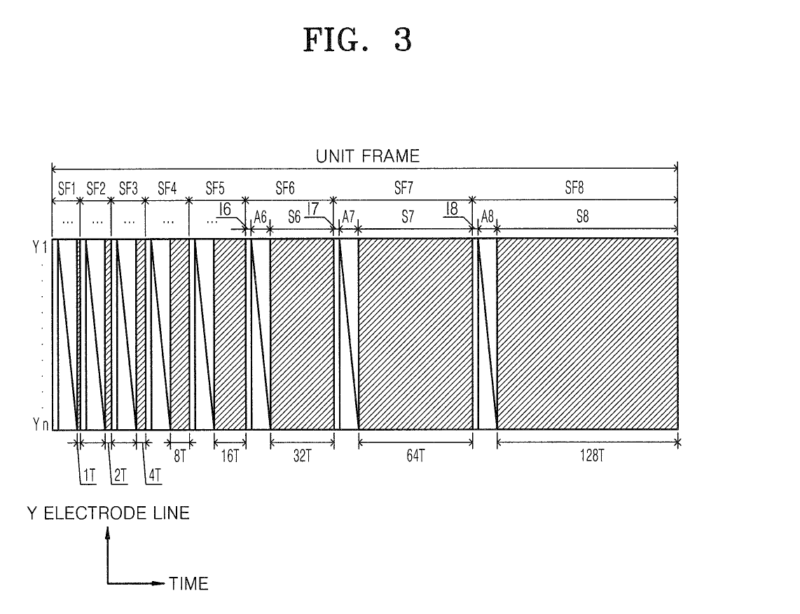

FIG. 3 is a timing diagram illustrating an address-display separation driving method with respect to the scan electrode lines Y₁ through Yₙ of the PDP 1 of FIG. 1.

Referring to FIG. 3, each of frames is divided into 8 subfields SF1 through SF8 in order to realize a time division gray level display. The subfields SF1 through SF8 are further divided into reset periods 11 through 18, address periods A1 through A8, and sustain periods S1 through S8.

Discharge conditions of all the cells are uniform during each of the reset periods I1 through I8.

During each of the address periods A1 through A8, a display data signal is applied to the address electrode lines A_{R1} through A_{Bm}, and concurrently, a scan pulse is sequentially applied to the scan electrode lines Y₁ through Yₙ.

During each of the sustain periods S1 through S8, a sustain pulse is alternately applied to all the scan electrode lines Y₁ through Yₙ and all the sustain electrode lines X₁ through Xₙ, such that a display discharge is generated in discharge cells where a wall voltage greater than a preset level is formed during each of the address periods A1 through A8.

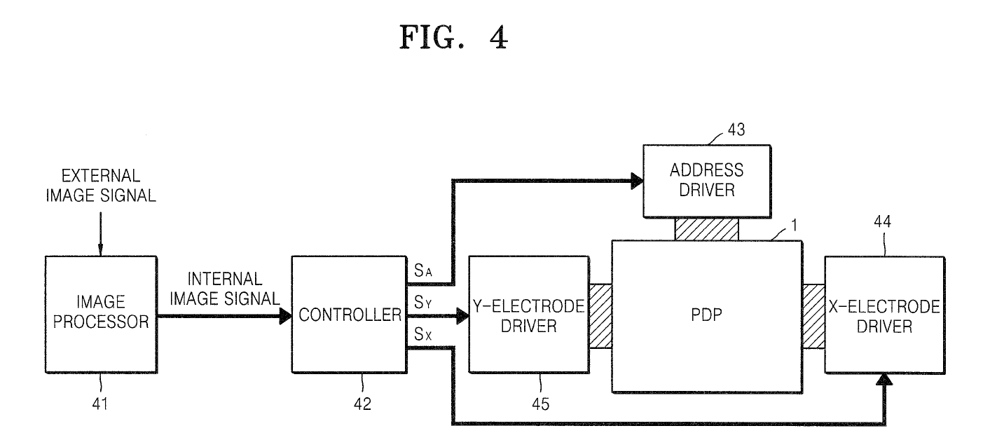

FIG. 4 is a block diagram of a plasma display apparatus according to an exemplary embodiment of the present invention.

Referring to FIG. 4, the plasma display apparatus includes the PDP 1 of FIG. 1 and a driving apparatus for driving the PDP 1. The driving apparatus includes an image processor 41, a controller 42, an address driver 43, an X-electrode driver 44, and a Y-electrode driver 45.

The image processor 41 converts an external analog image signal to a digital signal to generate an internal image signal, such as 8 bit-red (R), green (G), and blue (B) image data, a clock signal, and vertical and horizontal sync signals. The controller 42 generates driving control signals S_{A}, S_{Y}, and S_{X} according to the internal image signal output from the image processor 41.

The address driver 43 processes the address signal S_{A} among the driving control signals S_{A}, S_{Y}, and S_{X} output from the controller 42 to generate a display data signal, and applies the generated display data signal to the address electrode lines A_{R1} through A_{Bm} of the PDP 1. The X-electrode driver 44 processes the X-driving control signal S_{X} among the driving control signals S_{A}, S_{Y}, and S_{X} output from the controller 42 to drive the sustain electrode lines X₁ through Xₙ of the PDP 1. The Y-electrode driver 45 processes the Y-driving control signal S_{Y} among the driving control signals S_{A}, S_{Y}, and S_{X} output from the controller 42 to drive the scan electrode lines Y₁ through Yₙ (see FIG. 1) of the PDP 1.

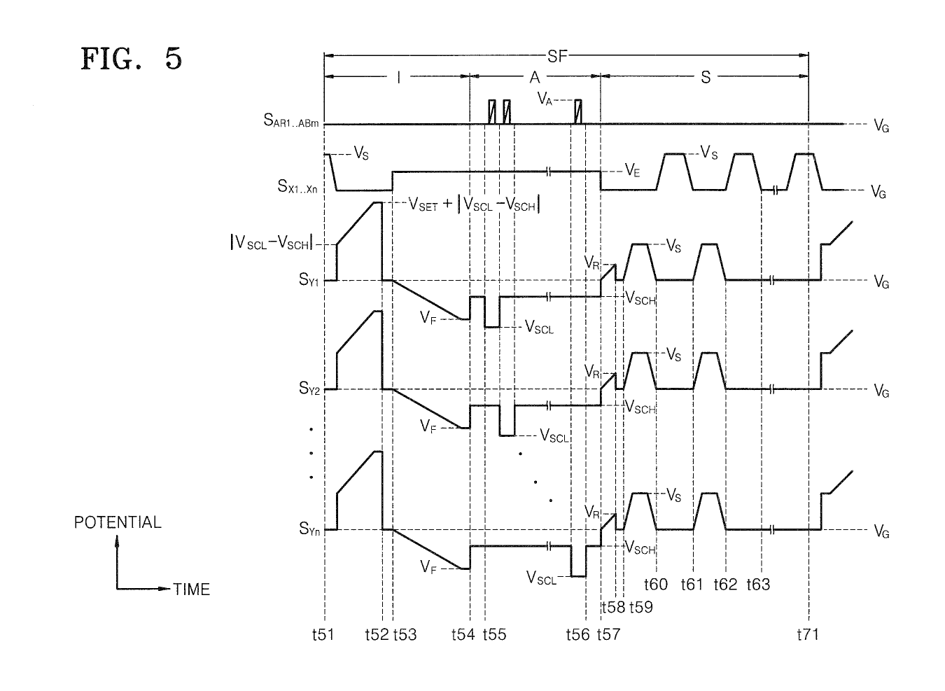

FIG. 5 is a timing diagram illustrating driving signals applied to the PDP 1 of FIG. 1 in a subfield SF, for explaining a method of driving the PDP 1 using the plasma display apparatus of FIG. 4 according to an exemplary embodiment of the present invention. In FIG. 5, a driving signal S_{AR1 . . . ABm} is applied to each of the address electrode lines A_{R1}, A_{G1}, . . . , A_{Gm}, A_{Bm} of the PDP 1, a driving signal S_{X1 . . . Xn} is applied to the sustain electrode lines X₁ through Xₙ of the PDP 1, and driving signals S_{Y1} through S_{Yn} are respectively applied to the scan electrode lines Y₁ through Yₙ of the PDP 1.

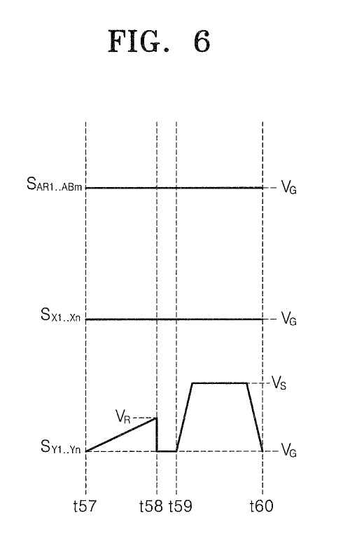

FIG. 6 is an enlarged timing diagram illustrating driving signals during a period from time t57 to time t60 of the subfield SF of FIG. 5. In FIG. 6, a driving signal S_{Y1 . . . Yn} is applied to all the scan electrode lines Y₁ through Yₙ of the PDP 1.

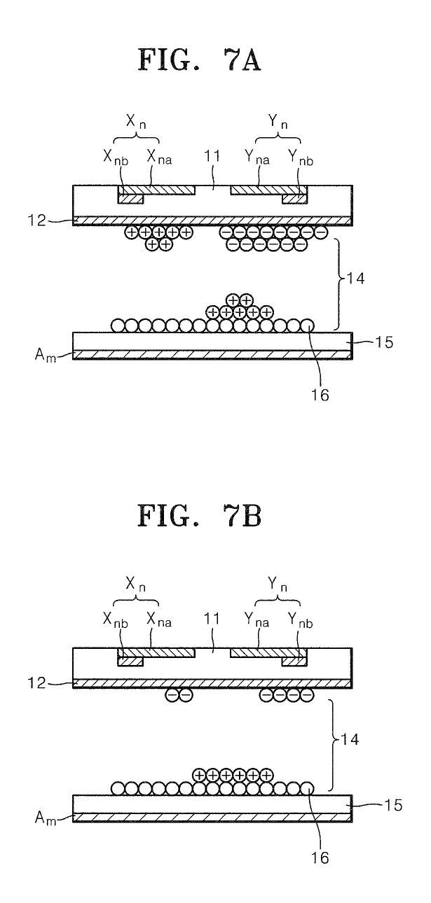

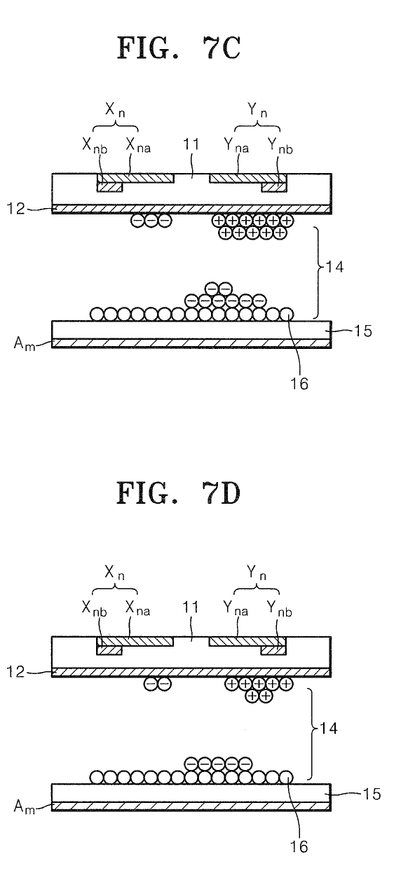

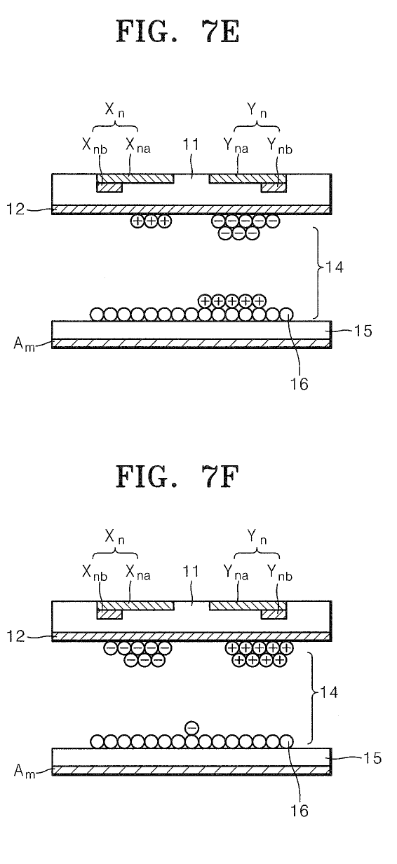

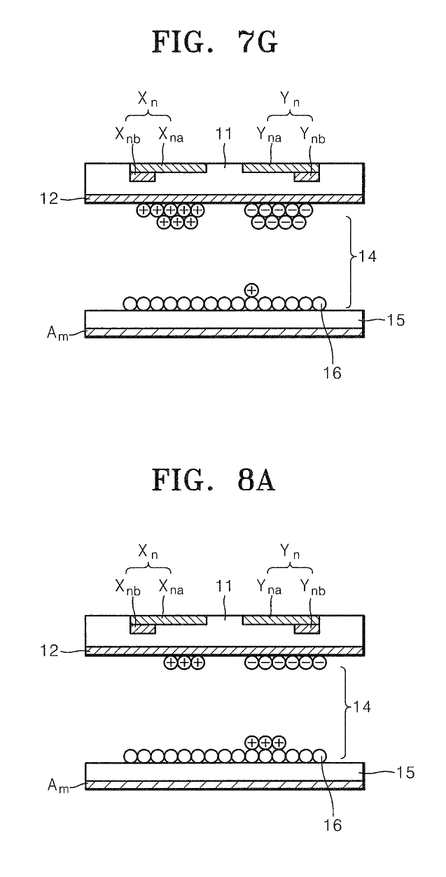

FIG. 7A is a cross-sectional view illustrating a wall charge distribution when wall charges are normally accumulated in a cell at time t52 of the subfield SF of FIG. 5. FIG. 7B is a cross-sectional view illustrating a wall charge distribution when the cell of FIG. 7A is normally reset at time t54 of the subfield SF of FIG. 5. FIG. 7C is a cross-sectional view illustrating a wall charge distribution when the cell of FIG. 7B is normally selected due to an address discharge at time t57 of the subfield SF of FIG. 5. FIG. 7D is a cross-sectional view illustrating wall charges left after some wall charges in the normally selected cell of FIG. 7C are erased at time t59 of the subfield SF of FIGS. 5 and 6. FIG. 7E is a cross-sectional view illustrating a wall charge distribution after a first sustain discharge occurs in the cell of FIG. 7D at time t60 of the subfield SF of FIGS. 5 and 6. FIG. 7F is a cross-sectional view illustrating a wall charge distribution after a second sustain discharge occurs in the cell of FIG. 7E at time t61 of the subfield SF of FIG. 5. FIG. 7G is a cross-sectional view illustrating a wall charge distribution after a third sustain discharge occurs in the cell of FIG. 7F at time t62 of the subfield SF of FIG. 5.

Like reference numerals in FIGS. 2 and 7A through 7G denote like elements. The method of FIG. 5 will now be explained with reference to FIGS. 1, 5, 6, and 7A through 7G.

During a potential rising period t51 through t52 of a reset period I of the subfield SF, a potential applied to the scan electrode lines Y₁ through Yₙ continuously rises from a fifth potential |V_{SCL}−V_{SCH}|, for example, 140 V, to a first potential V_{SET}+|V_{SCL}−V_{SCH}|, for example, 335 V, which is higher than the fifth potential |V_{SCL}−V_{SCH}| by a sixth potential V_{SET}, for example, 195 V. Here, the fifth potential |V_{SCc}−V_{SCH}| is a difference between a third potential V_{SCH}, which is a scan-bias potential, for example, −50 V, and a fourth potential V_{SCL}, which is a scan potential, for example, −190 V. Here, a ground potential V_{G}, that is, 0 V, is applied to the sustain electrode lines X₁ through Xₙ and the address electrode lines A_{R1} through A_{Bm}.

Accordingly, a discharge is generated between the scan electrode lines Y₁ through Yₙ and the sustain electrode lines X₁ through Xₙ, and a discharge is also generated between the scan electrode lines Y₁ through Yₙ and the address electrode lines A_{R1} through A_{Bm}. Accordingly, many wall charges having a negative polarity are formed around the scan electrode lines Y₁ through Yₙ; wall charges having a positive polarity are formed around the sustain electrode lines X₁ through Xₙ; and wall charges having a positive polarity are formed around the address electrode lines A_{R1} through A_{Bm} as shown in FIG. 7A.

Next, during a first potential falling period t52 through t53 of the reset period I, while the ground potential V_{G} is continuously applied to the sustain electrode lines X₁ through Xₙ, the potential applied to the scan electrode lines Y₁ through Yₙ steeply falls from the first potential V_{SET}+|V_{SCL}−V_{SCH}| to a ground potential V_{G}. Here, a ground potential V_{G} is applied to the address electrode lines A_{R1} through A_{Bm}.

Next, during a second potential falling period t53 through t54 of the reset period I, the potential applied to the scan electrode lines Y₁ through Yₙ smoothly falls from the ground potential V_{G} to a second potential V_{F}, which is a potential having a negative polarity, for example, −168 V. Here, a ground potential V_{G} is applied to the address electrode lines A_{R1} through A_{Bm} and an eighth potential V_{E}, for example, 95 V, is applied to the sustain electrode lines X₁ through Xₙ.

During the potential falling period t52 through t54, due to a discharge between the sustain electrode lines X₁ through Xₙ and the scan electrode lines Y₁ through Yₙ, the wall charges having a negative polarity formed around the scan electrode lines Y₁ through Yₙ are properly reduced, the wall charges having a negative polarity are properly formed around the sustain electrode lines X₁ through Xₙ, and the wall charges having a positive polarity formed around the address electrode lines A_{R1} through A_{Bm} are properly reduced as shown in FIG. 7B.

Accordingly, during a subsequent address period A, a display data signal is applied to the address electrode lines A_{R1} through A_{Bm} and a scan pulse of the fourth potential V_{SCL} is sequentially applied to the scan electrode lines Y₁ through Yₙ biased to the third potential V_{SCH}, thereby performing a smooth address operation. Here, the eighth potential V_{E}, which is a bias potential having a positive polarity, is continuously applied to the sustain electrode lines X₁ through Xₙ.

The third potential V_{SCH}, which is a scan-bias potential having a negative polarity, is lower than a ground potential V_{G} and higher than a second potential V_{F}, which is a reset falling potential. However, the fourth potential V_{SCL}, which is a scan potential, is lower than the second potential V_{F}.

When a cell is selected for discharge, an address potential V_{A}, for example, 65 V, is applied to the corresponding address electrode line A_{R1} through A_{Bm}, and otherwise, a ground potential V_{G} is applied to the corresponding address electrode line A_{R1} through A_{Bm}. Accordingly, when a display data signal of an address potential V_{A} is applied while a scan pulse of a fourth potential V_{SCL} is applied, a sustain discharge is enabled due to an address discharge in the corresponding selected cell, resulting in a distribution of wall charges as shown in FIG. 7C, and a sustain discharge is not enabled in a non-selected cell.

Early in the subsequent sustain period S, for example, at the beginning of the sustain period, at t57 through t59, an erase pulse is applied to the scan electrode lines Y₁ through Yₙ so as to reduce wall charges of all the cells. During the period t57 through t59, a ground potential is applied to the sustain electrode lines X₁ through Xₙ and the address electrode lines A_{R1} through A_{Bm}.

Here, the width t57 through t58 of the erase pulse is less than the width t59 through t60 of a sustain discharge pulse. For example, in one embodiment, if the address period A is 1 ms and the width t59 through t60 of the sustain discharge pulse is 22 μs, the width t57 and t58 of the erase pulse ranges from 13 to 16 μs.

Also, the erase pulse has a rising edge that rises more gradually than that of the sustain discharge pulse, and has a falling edge that falls more sharply than that of the sustain discharge pulse. The level V_{R} of the erase pulse is lower than the level V_{S}, for example, 207 V, of the sustain discharge pulse, and is higher than the eighth potential V_{E}, for example, 95 V. For example, the level V_{R} of the erase pulse may range from 130 to 160 V.

Accordingly, wall charges of all the cells are reduced due to an erase discharge during the early stage t57 through t59 of the sustain period S. However, wall charges for a sustain discharge are sufficiently formed in normally selected cells during the address period A as shown in FIG. 7C. Accordingly, even when the wall charges are reduced due to the erase discharge as shown in FIG. 7D, a sustain discharge can be normally generated in the selected cells.

After the early stage t57 through t59 of the sustain period S, during a remaining period t59 through t71 of the sustain period S, a seventh potential V_{S}, for example, a sustain pulse of 207 V, is alternately applied to all the scan electrode lines Y₁ through Yₙ and the sustain electrode lines X₁ through Xₙ, and thus a sustain discharge is generated in the cells selected during the address period A as shown in FIGS. 7E through 7G.

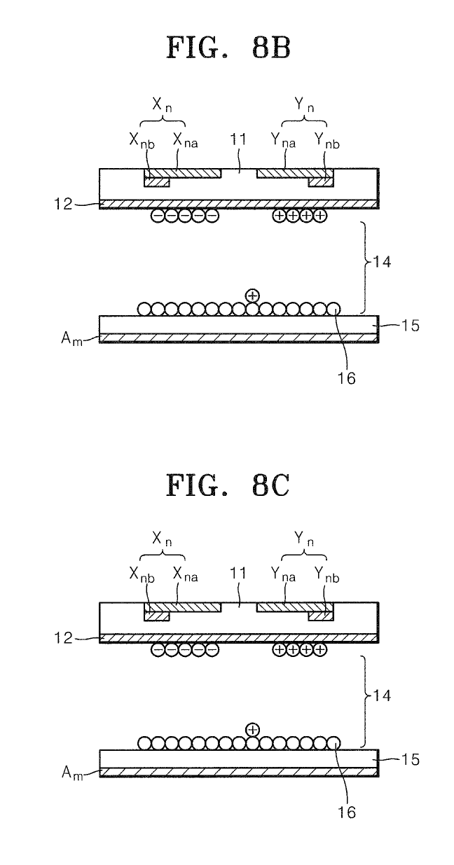

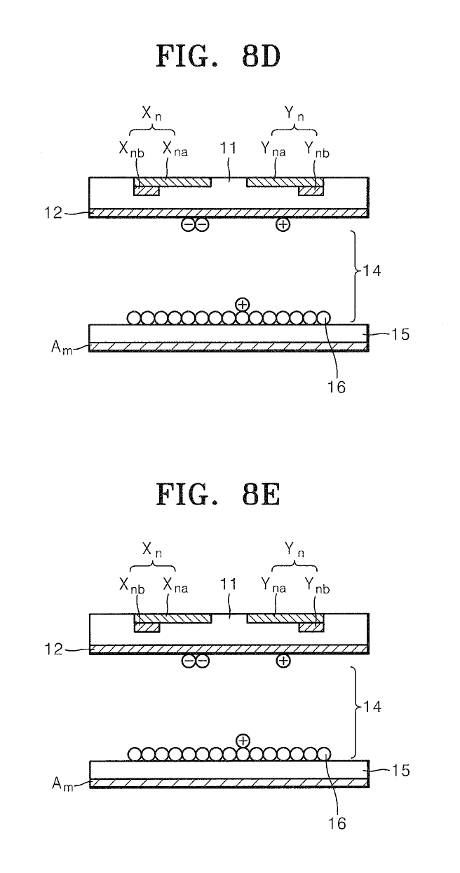

FIG. 8A is a cross-sectional view illustrating a wall charge distribution when wall charges are insufficiently accumulated in a cell at time t52 of the subfield SF of FIG. 5. Like reference numerals in FIGS. 2 and 8A through 8E denote like elements. As can bee seen by comparing FIGS. 7A and 8A, wall charges fail to be uniformly accumulated in all cells due to properties of phosphor materials, coating thickness, barrier rib height, and so on as illustrated in FIG. 8A.

FIG. 8B is a cross-sectional view illustrating that the cell of FIG. 8A is abnormally reset at time t54 of the subfield SF of FIG. 5. As can be seen by comparing FIGS. 7B and 8B, for proper operation wall charges having a negative polarity should be formed around all the scan electrode lines Y₁ through Yₙ, but in some cases wall charges having a positive polarity may be formed around the scan electrode lines Y₁ through Yₙ. This is because wall charges may be insufficiently accumulated at time t52 of the subfield SF of FIG. 5 as shown in FIG. 8A. However, even if wall charges were sufficiently accumulated at time t52 of the subfield SF of FIG. 5, the wall charges may fail to be properly distributed at time t54 due to properties of phosphor materials, coating thickness, barrier rib height, and so on.

FIG. 8C is a cross-sectional view illustrating wall charges when the cell of FIG. 8B is not selected at time t57 of the subfield SF of FIG. 5. As can be seen by comparing FIGS. 7C and 8C, even though the cell of FIG. 8B is not selected and thus a discharge is not generated in the cell of FIG. 8B, conditions, although unsatisfactory, for a sustain discharge may be present.

FIG. 8D is a cross-sectional view illustrating wall charges left after some wall charges in the cell of FIG. 8C are erased at time t59 of the subfield SF of FIGS. 5 and 6. As can be seen by comparing FIGS. 7D and 8D, since wall charges are not sufficiently formed in the cell of FIG. 8C, conditions for a sustain discharge may be removed due to an erase discharge.

FIG. 8E is a cross-sectional view illustrating that a sustain discharge does not occur in the cell of FIG. 8D at time t60 of the subfield SF of FIGS. 5 and 6. As can be seen by comparing FIGS. 7E and 8E, since conditions for a sustain discharge are removed in the cell of FIG. 8D, a sustain discharge is not generated in the cell. Of course, no sustain discharge is generated in a cell, in which an initial sustain discharge does not occur during the sustain period S of the subfield SF of FIG. 5, until the sustain period S ends.

Accordingly, once wall charges are reduced due to the erase discharge, the probability that a sustain discharge is generated in the non-selected cell is greatly reduced.

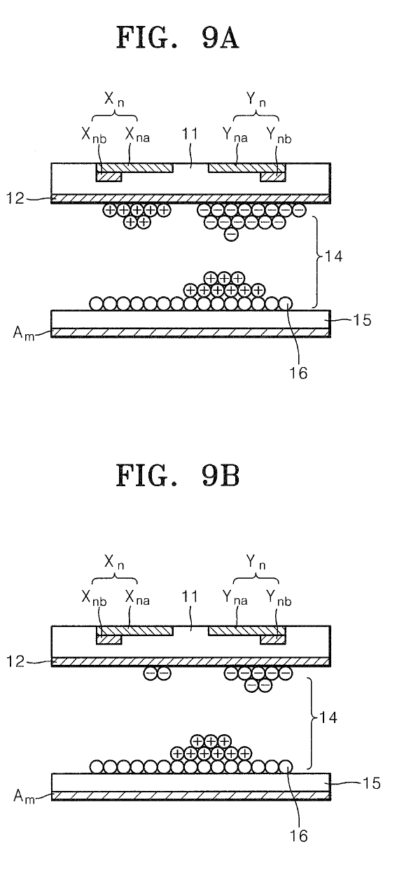

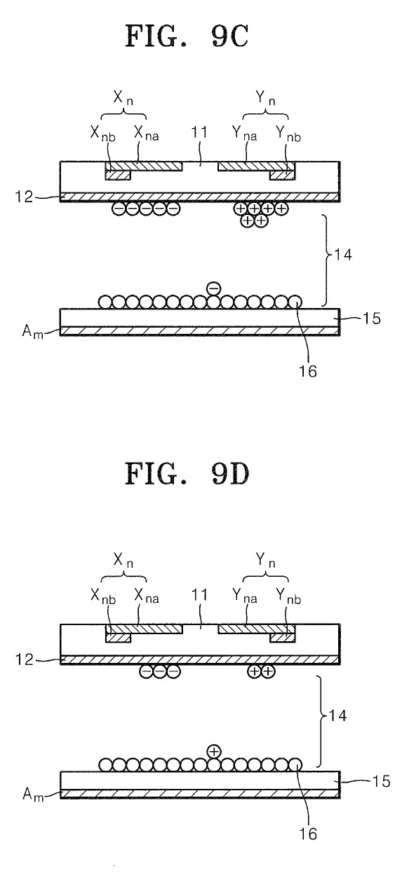

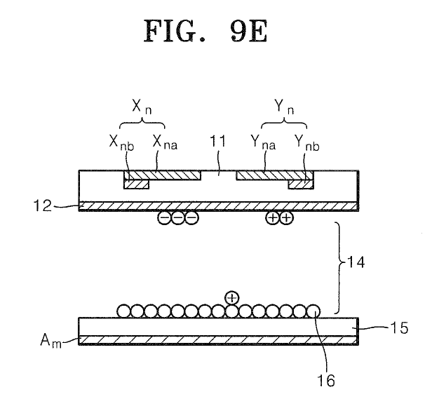

FIG. 9A is a cross-sectional view illustrating a wall charge discharge when wall charges are excessively accumulated in a cell at time t52 of the subfield SF of FIG. 5. Like reference numerals in FIGS. 2 and 9A through 9E denote like elements. When comparing between FIGS. 7A and 9A, wall charges fail to be uniformly accumulated in all cells due to properties of phosphor materials, coating thickness, barrier rib height, and so on.

FIG. 9B is a cross-sectional view illustrating a wall charge distribution when wall charges are excessively accumulated in the cell of FIG. 9A at time t54 of the subfield SF of FIG. 5. As can be seen by comparing FIGS. 7B and 9B, there may exist cells in which wall charges are excessively formed at time t54 when the reset period I ends. This is because wall charges are excessively accumulated at time t52 of the subfield SF of FIG. 5 as shown in FIG. 9A. However, even if wall charges were properly accumulated at time t52 of the subfield SF of FIG. 5, the wall charges may fail to be uniformly distributed due to properties of phosphor materials, coating thickness, barrier rib height, and so on.

FIG. 9C is a cross-sectional view illustrating the wall charge distribution at time t57 of the subfield SF of FIG. 5, showing that a discharge occurred during the address period in the cell of FIG. 9B, which was not selected. As can be seen by comparing FIGS. 7C and 9C, because a weak discharge was generated in the non-selected cell of FIG. 9B, conditions, although unsatisfactory, for a sustain discharge may be present.

FIG. 9D is a cross-sectional view illustrating wall charges left at time t59 of the subfield SF of FIGS. 5 and 6, after some wall charges in the cell of FIG. 9C were erased by the erase discharge. As can be seen by comparing FIGS. 7D and 9D, because wall charges are not sufficiently formed in the cell of FIG. 9C, conditions for a sustain discharge may be removed due to an erase discharge.

FIG. 9E is a cross-sectional view illustrating that a sustain discharge does not occur in the cell of FIG. 9D at time t60 of the subfield SF of FIGS. 5 and 6. As can be seen by comparing FIGS. 7E and 9E, since conditions for a sustain discharge are removed in the cell of FIG. 9D, a sustain discharge is not generated in the cell. Of course, no sustain discharge is generated in a cell, in which an initial sustain discharge does not occur during the sustain period S of the subfield SF of FIG. 5, until the sustain period S ends.

Accordingly, once wall charges are reduced due to the erase discharge, the probability that a sustain discharge is generated in the non-selected cell is greatly reduced.

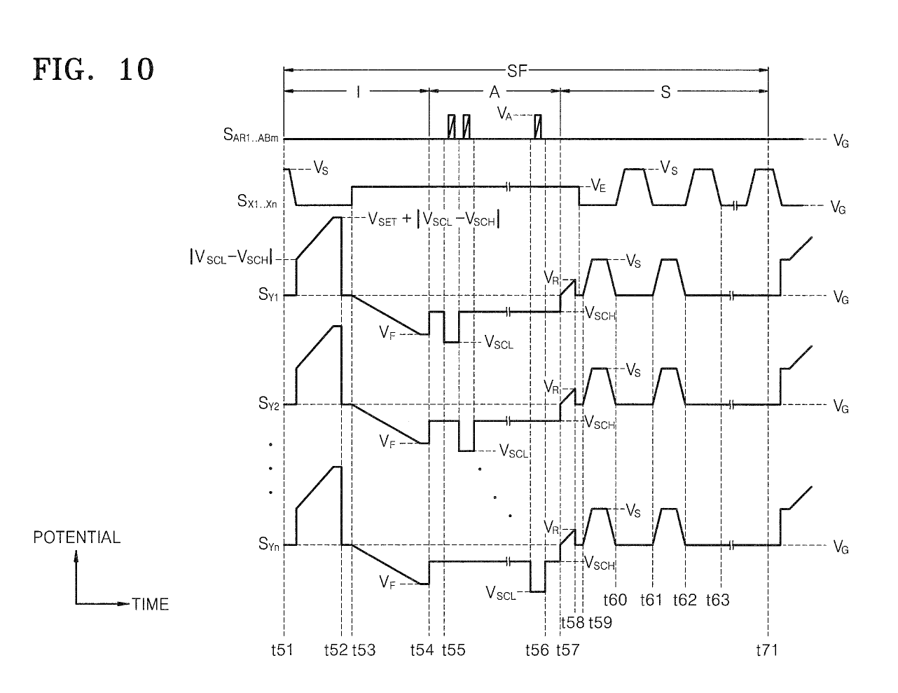

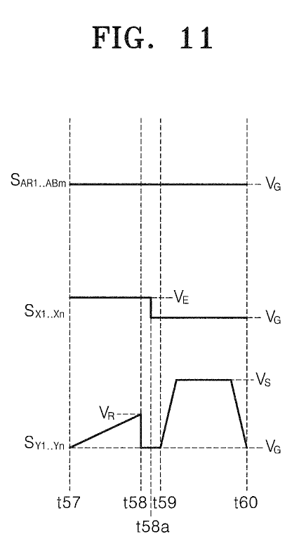

FIG. 10 is a timing diagram illustrating driving signals applied to the PDP 1 of FIG. 1 in a subfield SF, for explaining a method of driving the PDP 1 using the plasma display apparatus of FIG. 4 according to another exemplary embodiment of the present invention. FIG. 11 is an enlarged timing diagram illustrating driving signals during a period from time t57 to time t60 of the subfield SF of FIG. 10.

Like reference numerals in FIGS. 5 and 6 and FIGS. 10 and 11 denote like elements. Accordingly, an explanation focusing on a difference between the method of FIGS. 5 and 6 and the method of FIGS. 10 and 11 will now be made.

As described above, during an early stage t57 through t59 of a sustain period S, an erase pulse is applied to the scan electrode lines Y₁ through Yₙ so as to reduce wall charges of all the cells.

During the period t57 through t59, an eighth potential V_{E}, which is a bias potential having the same polarity as that of the erase pulse, is applied to the sustain electrode lines X₁ through Xₙ.

As described above, the level V_{R} of the erase pulse is lower than the level of a sustain discharge pulse, for example, 207 V and is higher than the level of the eighth potential V_{E}, for example, 95 V. For example, the level V_{R} of the erase pulse may range from 130 to 160 V.

A ground potential is applied to the address electrode lines A_{R1} through A_{Bm}. Of course, a potential different from the ground potential may be applied to the address electrode lines A_{R1} through A_{Bm}. Also, the address electrode lines A_{R1} through A_{Bm} may be floated.

FIG. 12 is a cross-sectional view illustrating wall charges left after some wall charges in a normally selected cell as illustrated in FIG. 7C are erased at time t59 of a subfield SF of FIGS. 10 and 11. Accordingly, the cross-sectional view of FIG. 12 corresponds to the cross-sectional view of FIG. 7D.

As can be seen by comparing FIGS. 12 and 7D, during the period t57 through t59 in which the erase pulse is applied, since the eighth potential V_{E}, which is the bias potential having the same polarity as that of the erase pulse, is applied to the sustain electrode lines X₁ through Xₙ, charges having a negative polarity formed around the address electrode lines A_{R1} through A_{Bm} are reduced as much as charges having a negative polarity formed around the sustain electrode lines X₁ through Xₙ are increased.

Accordingly, brightness can be improved in a subsequent sustain discharge.

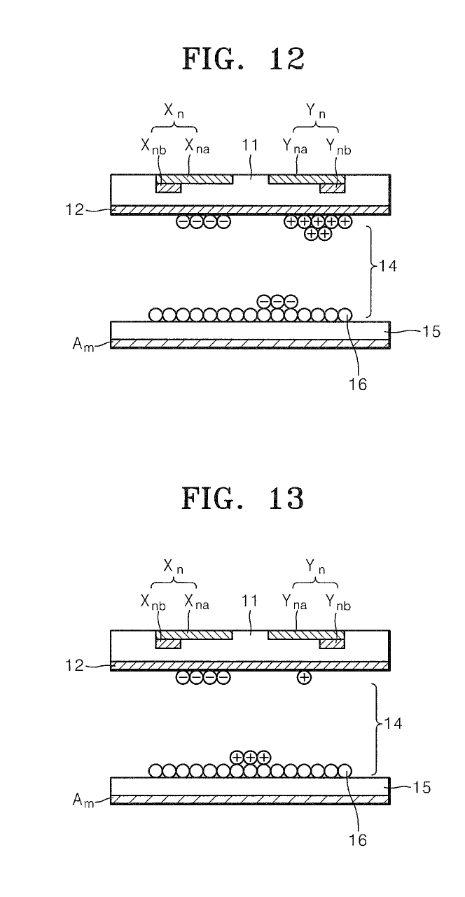

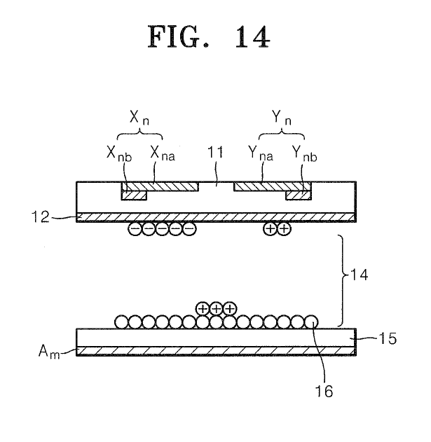

FIG. 13 is a cross-sectional view illustrating wall charges left after some wall charges in the cell of FIG. 8C are erased at time t59 of the subfield SF of FIGS. 10 and 11. Accordingly, the cross-sectional view of FIG. 13 corresponds to the cross-sectional view of FIG. 8D.

As can be seen by comparing FIGS. 13 and 8D, during the period t57 through t59 in which the erase pulse is applied, since the eighth potential V_{E}, which is the bias potential having the same polarity as that of the erase pulse, is applied to the sustain electrode lines X₁ through Xₙ, charges having a positive polarity formed around the address electrode lines A_{R1} through A_{Bm} are increased as much as charges having a negative polarity formed around the sustain electrode lines X₁ through Xₙ are increased.

However, because wall charges are not sufficiently formed in the cell of FIG. 8C, conditions for a sustain discharge are removed due to an erase discharge.

FIG. 14 is a cross-sectional view illustrating wall charges left after some wall charges in the cell of FIG. 9C are erased at time t59 of the subfield SF of FIGS. 10 and 11. Accordingly, the cross-sectional view of FIG. 14 corresponds to the cross-sectional view of FIG. 9D.

As can be seen by comparing FIGS. 14 and 9D, during the period t57 through t59 in which the erase pulse is applied, since the eighth potential V_{E}, which is the bias potential having the same polarity as that of the erase pulse, is applied to the sustain electrode lines X₁ through Xₙ, charges having a positive polarity formed around the address electrode lines A_{R1} through A_{Bm} are increased as much as charges having a negative polarity formed around the sustain electrode lines X₁ through Xₙ are increased.

However, because wall charges are not sufficiently formed in the cell of FIG. 9C, conditions for a sustain discharge are removed due to an erase discharge.

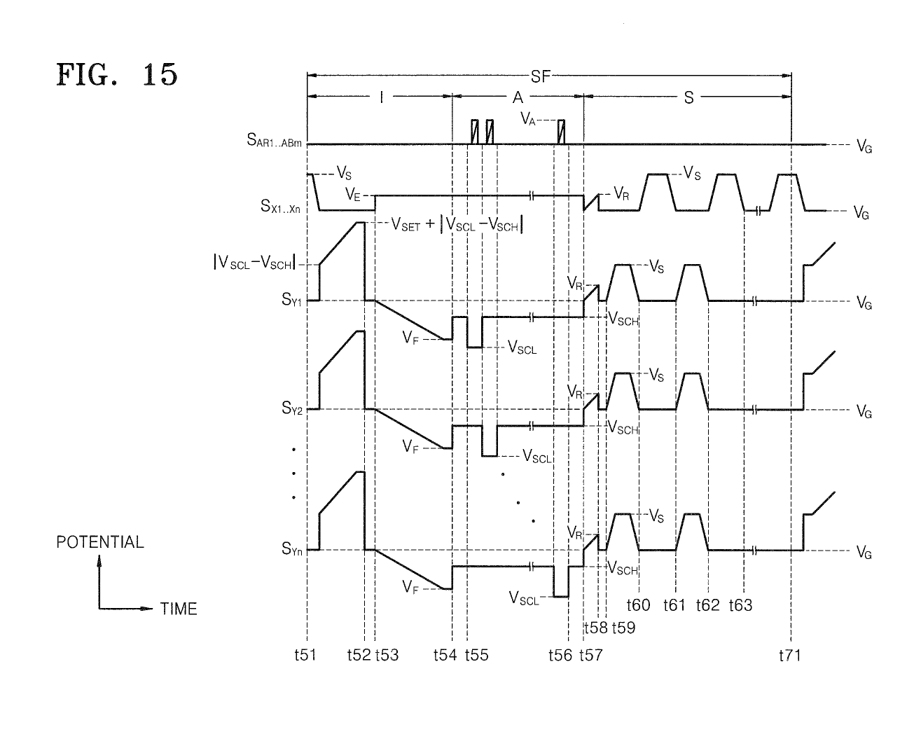

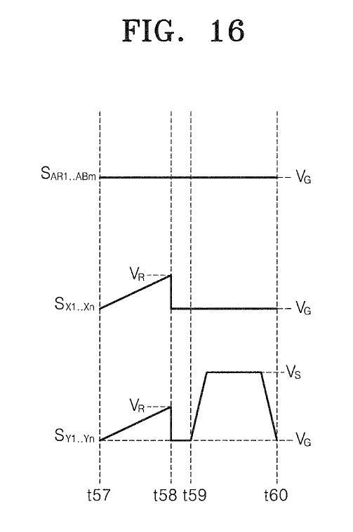

FIG. 15 is a timing diagram illustrating driving signals applied to the PDP 1 of FIG. 1 in a subfield SF, for explaining a method of driving the PDP 1 using the plasma display apparatus of FIG. 4 according to another exemplary embodiment of the present invention. FIG. 16 is an enlarged timing diagram illustrating driving signals during a period from time t57 to time t60 of the subfield SF of FIG. 15.

Like reference numerals in FIGS. 5 and 6 and FIGS. 15 and 16 denote like elements. Accordingly, an explanation focusing on a difference between the method of FIGS. 5 and 6 and the method of FIGS. 15 and 16 will now be made.

As described above, during an early stage t57 through t59 of a sustain period S, an erase pulse is applied to scan electrode lines Y₁ through Yₙ so as to reduce wall charges of all the cells.

During the period t57 through t59, an erase pulse having essentially the same characteristics is also applied to the sustain electrode lines X₁ through Xₙ. Here, an electrostatic capacitance is formed between the scan electrode lines Y₁ through Yₙ and the sustain electrode lines X₁ through Xₙ. Accordingly, the erase pulse may be applied to the sustain electrode lines X₁ through Xₙ as the sustain electrode lines X₁ through Xₙ are electrically floated. That is, when the sustain electrode lines X₁ through Xₙ are electrically floated, a potential of the scan electrode lines Y₁ through Yₙ is gradually increased and a potential of the sustain electrode lines X₁ through Xₙ is also increased in proportion to the increase in the potential of the scan electrode lines Y₁ through Yₙ.

A ground potential is applied to the address electrode lines A_{R1} through A_{Bm}. As described above, a potential different from the ground potential may be applied to the address electrode lines A_{R1} through A_{Bm}. Also, the address electrode lines A_{R1} through A_{Bm} may be floated.

For reference, an embodiment of the method of FIGS. 15 and 16 is the same as that of the method described with reference to FIGS. 12 through 14

As described above, according to the method of driving the PDP and the plasma display apparatus using the method according to the present invention, an erase discharge is generated so as to reduce the wall charges of all the cells of the PDP. Accordingly, even though a reset or address operation may fail to be uniformly carried out in all the cells due to variations in the manufacture of the PDP, image reproducibility can be improved for the following reasons.

First, wall charges for a sustain discharge are sufficiently formed in normally selected cells during an address period. Accordingly, although the wall charges are reduced due to an erase discharge, a sustain discharge can be normally generated in the selected cells.

Second, in a conventional driving method, a sustain discharge may occur during a sustain period in non-selected cells, which abnormally operate during a reset period although a discharge does not occur in the non-selected cells during an address period. However, according to embodiments of the present invention, wall charges for a sustain discharge are not sufficiently formed in the non-selected cells, compared to normally selected cells, during an address period. Accordingly, when the wall charges are reduced due to the erase discharge, a sustain discharge cannot be generated in the non-selected cells.

Third, when a discharge occurs in adjacent selected cells during an address period, a discharge may occur in the non-selected cells, thereby generating a sustain discharge during a sustain period. However, since a discharge occurs in the non-selected cells while a selected potential is not applied to a data electrode, wall charges for a sustain discharge are not sufficiently formed in the non-selected cells during an address period. Accordingly, when the wall charges are reduced due to the erase discharge, a sustain discharge cannot be generated in the non-selected cells.

While the present invention has been particularly shown and described with reference to exemplary embodiments thereof, it will be understood by those of ordinary skill in the art that various changes in form and details may be made therein without departing from the spirit of the present invention, the scope of which is defined by the following claims and their equivalents.

What is claimed is:

1. A method of driving a plasma display panel (PDP) during a field comprising a plurality of subfields, each subfield comprising a reset period, an address period, and a sustain period, the PDP comprising scan electrode lines, sustain electrode lines parallel to the scan electrode lines, and address electrode lines crossing the scan electrode lines and the sustain electrode lines at a plurality of cells, the method comprising:
initializing wall charges of the cells during the reset period;
generating a discharge in selected cells of the plurality of cells during the address period to enable a sustain discharge in the selected cells;
generating the sustain discharge in the selected cells during the sustain period; and
applying an erase pulse to the scan electrode lines early in the sustain period.

2. The method of claim 1, wherein generating the sustain discharge comprises alternately applying a sustain pulse to the scan electrode lines and the sustain electrode lines,
wherein the erase pulse is shorter than the sustain pulse.

3. The method of claim 2, wherein the erase pulse has a rising edge rising more gradually than that of the sustain pulse.

4. The method of claim 2, wherein the erase pulse has a falling edge falling more sharply than that of the sustain pulse.

5. The method of claim 2, wherein a ground potential is applied to the sustain electrode lines while the erase pulse is applied to the scan electrode lines early in the sustain period.

6. The method of claim 2, wherein a bias potential is applied to the sustain electrode lines while the erase pulse is applied to the scan electrode lines early in the sustain period.

7. The method of claim 2, further comprising applying a bias potential to the sustain electrode lines while the erase pulse is applied, the bias potential having a same polarity as that of the erase pulse.

8. The method of claim 2, wherein another erase pulse is applied to the sustain electrode lines while the erase pulse is applied to the scan electrode lines early in the sustain period.

9. The method of claim 2, wherein, while the erase pulse is applied to the scan electrode lines early in the sustain period, a first erase pulse is applied to the sustain electrode lines as the sustain electrode lines are electrically floated.

10. The method of claim 1, wherein a sustain pulse is alternately applied to the scan electrode lines and the sustain electrode lines during the sustain period, and
wherein the erase pulse has a lower level than that of the sustain pulse.

11. The method of claim 10, wherein the erase pulse has a rising edge rising more gradually than that of the sustain pulse.

12. The method of claim 10, wherein the erase pulse has a falling edge falling more sharply than that of the sustain pulse.

13. The method of claim 10, further comprising applying a ground potential to the sustain electrode lines while the erase pulse is applied to the scan electrode lines early in the sustain period.

14. The method of claim 10, further comprising applying a bias potential to the sustain electrode lines while the erase pulse is applied to the scan electrode lines early in the sustain period.

15. The method of claim 10, further comprising applying a bias potential to the sustain electrode lines while the erase pulse is applied, the bias potential having the same polarity as that of the erase pulse.

16. The method of claim 10, wherein a first erase pulse is applied to the sustain electrode lines while the erase pulse is applied to the scan electrode lines early in the sustain period.

17. The method of claim 10, wherein, while the erase pulse is applied to the scan electrode lines early in the sustain period, a first erase pulse is applied to the sustain electrode lines as the sustain electrode lines are electrically floated.

18. A plasma display apparatus comprising:
a plasma display panel (PDP) comprising a plurality of discharge cells; and
at least one driver configured to drive the cells during a reset period, an address period, and a sustain period,
wherein wall charges of all cells of a PDP are initialized during the reset period;
wherein a sustain discharge is enabled by generating a discharge in selected cells during the address period;
wherein the sustain discharge is generated in the selected cells during the sustain period; and
wherein an erase discharge is generated in all the cells of the PDP early in the sustain period.
